(19) United States
(12) Patent Application Publication
(10) Pub. No.: US 2004/0059595 A1
(43) Pub. Date: Mar. 25, 2004

(54) Vehicle leasing program

(76) Inventor: Ralph Hoffmann, Eden Prairie, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/666,645

(22) Filed: Sep. 18, 2003

Related U.S. Application Data
(60) Provisional application No. 60/413,465, filed on Sep. 23, 2002.

(51) Int. Cl. G06F 17/60

(52) U.S. Cl. 705/1

(57) ABSTRACT

An inventive vehicle leasing or purchase evaluation system which includes a computer; a database of vehicle information; a computer program configured to run in the computer and having access to the database of vehicle information, and the computer program configured to provide a list of vehicles having a monthly payment falling within a user defined range, given a term and interest rate. The list may be sorted and filtered based on user provided criteria.

This application claims the benefit of Provisional Patent Application No. 60/413,465 filed Nov. 23, 2002, and the entire contents of which is hereby incorporated by reference.

### BACKGROUND OF THE INVENTION

### BRIEF SUMMARY OF THE INVENTION

The applicant has provided an inventive vehicle leasing or purchase evaluation system which includes a computer; a database of vehicle information; a computer program configured to run in the computer and having access to the database of vehicle information, and the computer program configured to provide a list of vehicles having a monthly lease or purchase payment falling within a user defined range, given a term and interest rate and tax status. The list may be sorted and filtered based on user provided criteria.

### BRIEF DESCRIPTION OF THE SEVERAL VIEWS OF THE DRAWING(S)

FIG. 1 shows a block diagram of the main screens of the program labeled Sheet 1;

FIG. 2 shows the “State, Term and Tax Status” screen no. 26;

FIG. 3 shows the “Choice Window” screen no. 29;

FIG. 4 shows a block diagram labeled Sheet 2 of the screens available if Lease and Monthly Payment are selected in screen no. 29 of FIG. 3;

FIG. 5 shows the “Leasing Window” screen no. 12;

FIG. 5A shows the help menu in FIG. 5;

FIG. 5B shows the “Sort data” menu in FIG. 5;

FIG. 6 shows the “Standard Features” screen no. 11 and the left half of screen no. 12;

FIG. 7 shows individual data for a selected vehicle (screen no. 20);

FIG. 7A shows a help screen which explains holdback;

FIG. 8 shows an amortization schedule for a selected vehicle (screen no. 2);

FIG. 9 shows the “Compare Two Vehicles” screen no. 12;

FIG. 10 shows the “Extra cost options for Cars” screen;

FIG. 11 shows the filtered form 20 with the options selected from FIG. 10 (screen no. 16);

FIG. 12 shows a list of features used for filtering (screen no. 19);

FIG. 13 shows the filtered form 20 with the features selected from FIG. 12 (screen no. 23);

FIG. 14 shows a block diagram labeled Sheet 3 of the screens available if Buy and Monthly Payment are selected in screen no. 29 of FIG. 3;

FIG. 15 shows the “Buying Window” screen no. 13;

FIG. 16 shows the slide bar used to change the monthly payment range and refilter screen no. 13;

FIG. 17 shows the “Compare Two Vehicles” screen no. 13; FIG. 18 shows a block diagram labeled Sheet 4 of the screens available if Maker and Buy or Lease are selected in screen no. 29 of FIG. 3;

FIG. 19 shows the “Find a Sedan (or Truck)” screen no. 14;

FIG. 20 shows an “Evaluate a Discount” screen no. 25.

FIG. 21 shows an Options selection screen no. 9; FIG. 22 shows a list of vehicles filtered with the options selected in FIG. 21;

FIG. 23 shows an Features selection screen no. 7;

FIG. 24 shows a list of vehicles filtered with the features selected in FIG. 23, and

FIG. 25 shows the “Lease Detective” screen no. 22.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

The detailed description utilizes terms which have the following definitions:

Residual value: The value of the vehicle at the end of the lease term. It is usually the wholesale value, but not necessarily, as it may differ on a given vehicle depending on which entity puts up the money to buy the vehicle from the manufacturer.

The inventive program is designed to be run on a computer having access to a vehicle information database, such as the database which is available for license from ALG, (Automotive Lease Guide) LLC, a California Limited Liability corporation. This database includes every four wheel passenger vehicle for sale in the US from all manufacturers (approximately 11,000). Other commercially available databases are available and could be utilized if desired.

The inventive program could also be run on a computer having an internet connection, with the program available from a server having an internet connection, and having access to the database.

The inventive program was written using Microsoft Visual Basic 6.0 and Microsoft Access, although it should be understood that it could be written in any commercially available programming language. The font size and font colors of all of the forms shown and described can be user selected by using the Microsoft common dialogs, as is well known in the art.

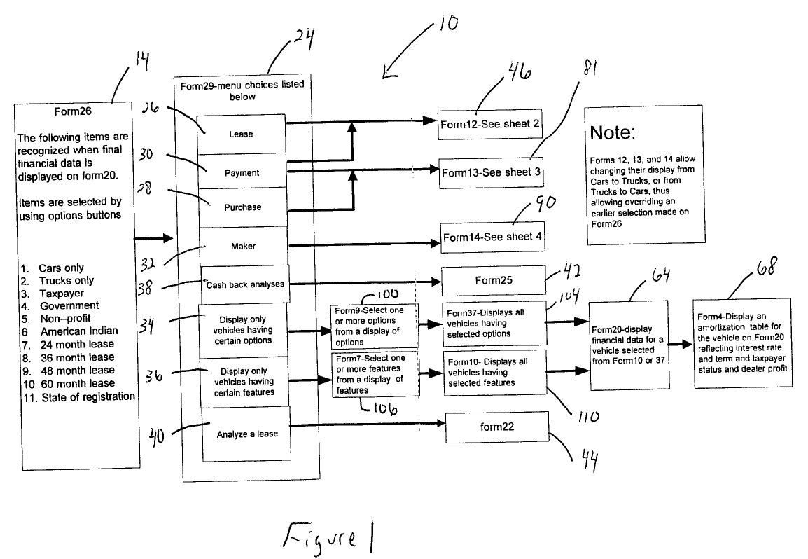

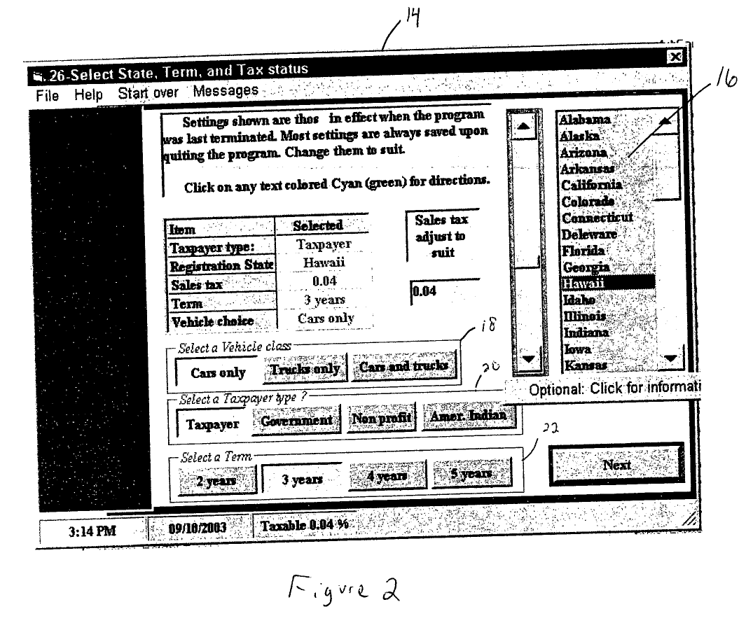

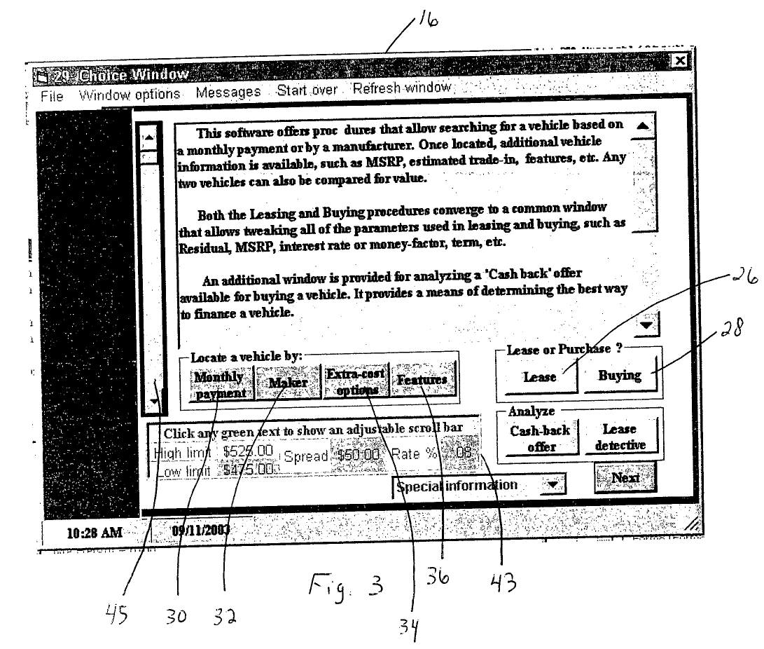

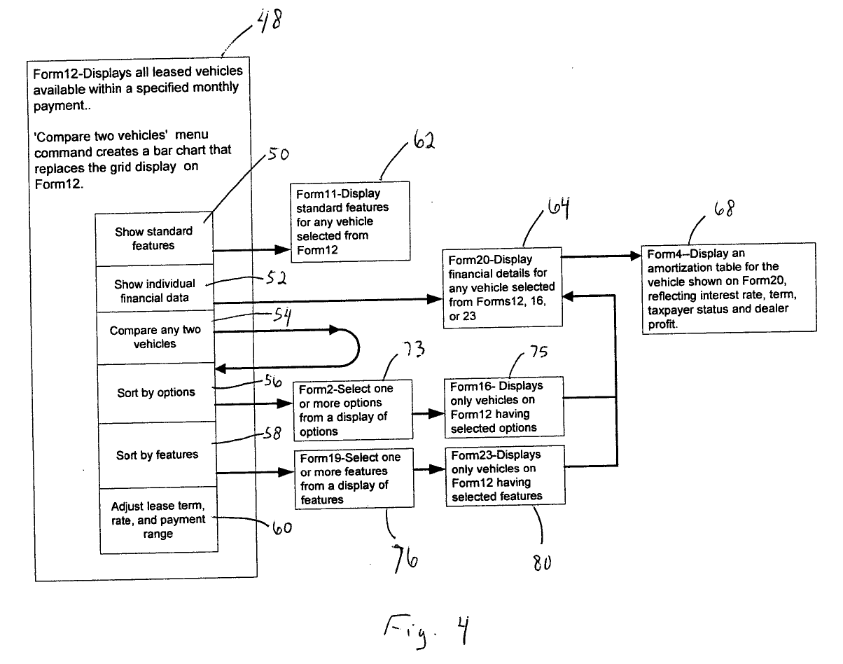

Referring now to FIG. 1, a block diagram of the inventive program is shown generally at 10. Block 14 refers to screen 26, FIG. 2, at which the user specifies the state, at reference numeral 16, the vehicle class, at reference numeral 18, the taxpayer type, at reference numeral 20, and the term of the lease or purchase, at reference numeral 22. When the user clicks the “Next” button on form 26, the user is taken to form or screen 29, which is reference numeral 24 in FIG. 1 and also shown in detail at FIG. 3.

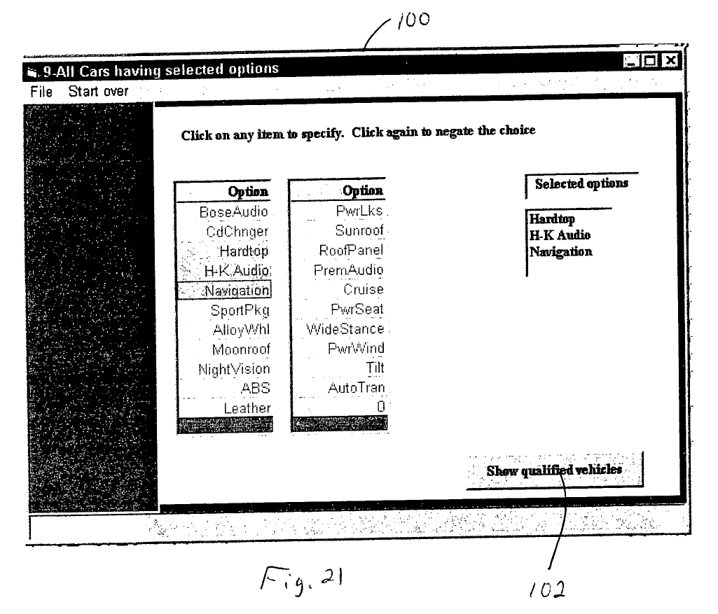

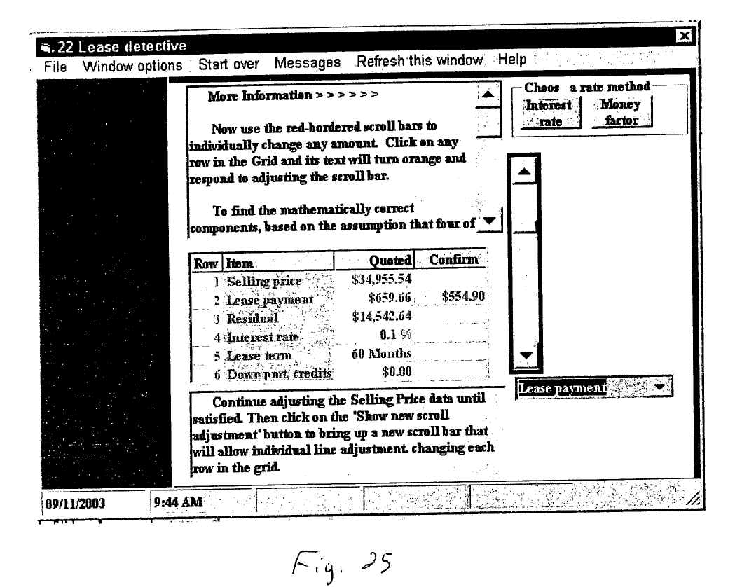

Referring now to reference numeral 24 and FIG. 3 (form 29), the user now selects an analysis based on either lease or purchase by clicking on either the lease button 26 or the buy button 28. The user also must select one of the four buttons 30, 32, 34 or 36, labeled respectively Monthly payment, Maker, Options and Features. Form 29 also has two other buttons available, the cash-back offer button 38 or the lease detective button 40. If the user selects either button 38 or 40, the forms identified as reference numerals 42 (see FIG. 20) and 44 (see FIG. 25) in FIG. 1 are immediately called up. Once the user selects any of the buttons 26, 28, 30, 32, 34 or 36 buttons 38 and 42 are hidden and not available as options unless the user starts over (available through the menu). Finally, a monthly payment (high limit, low limit and spread) are shown at 43. These amounts may be changed using the slide bar shown at 45.

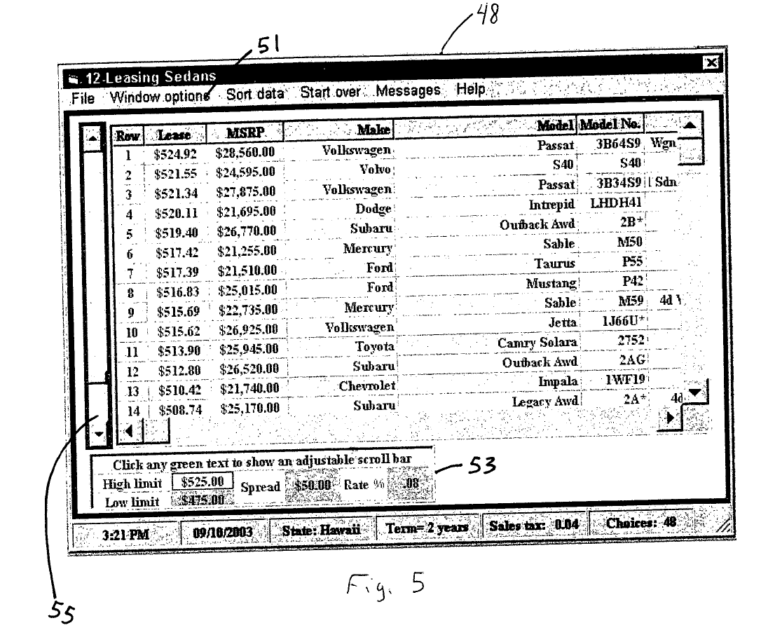

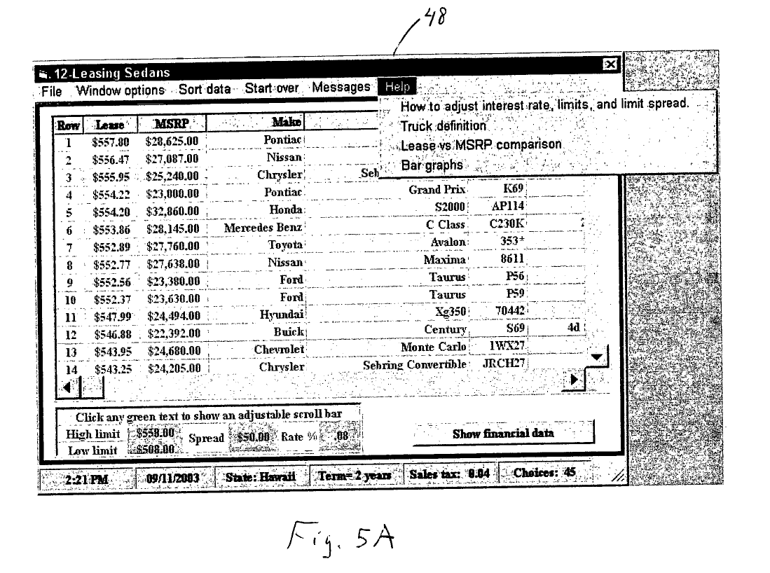

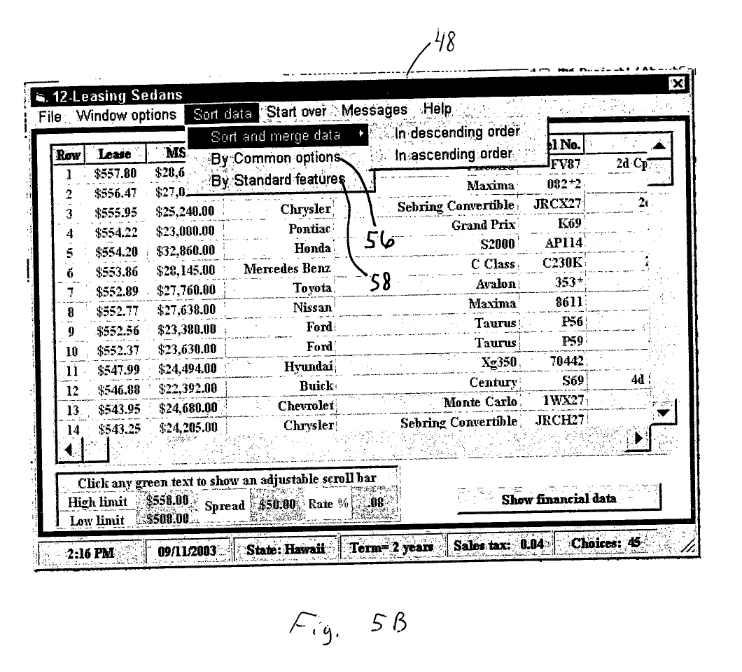

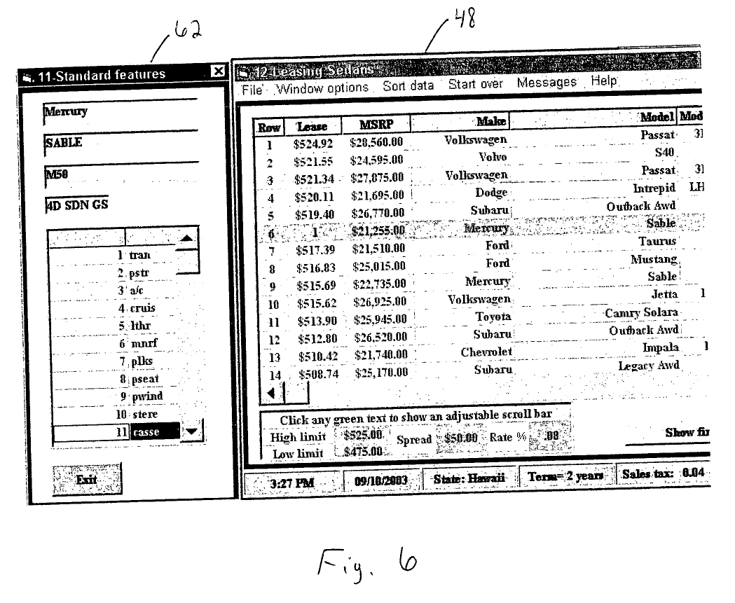

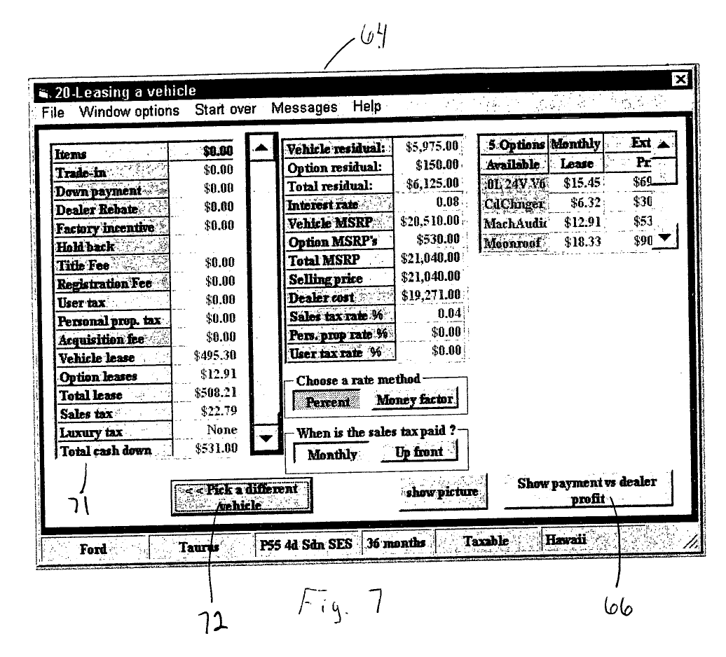

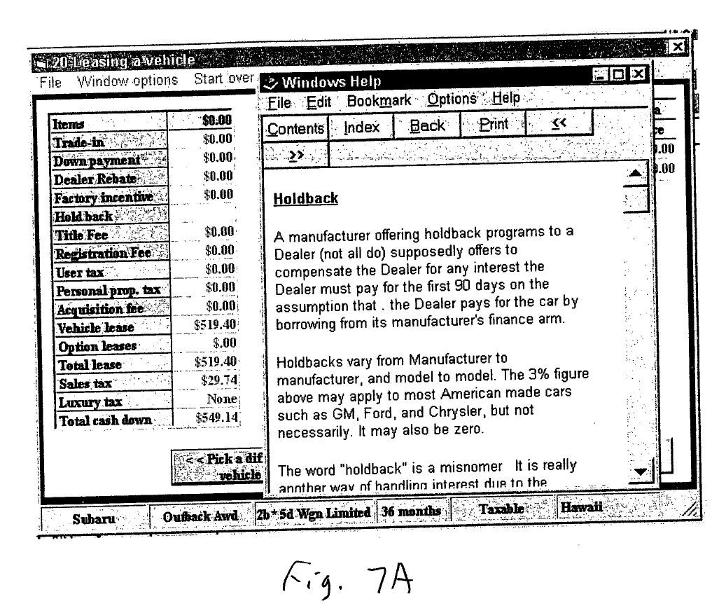

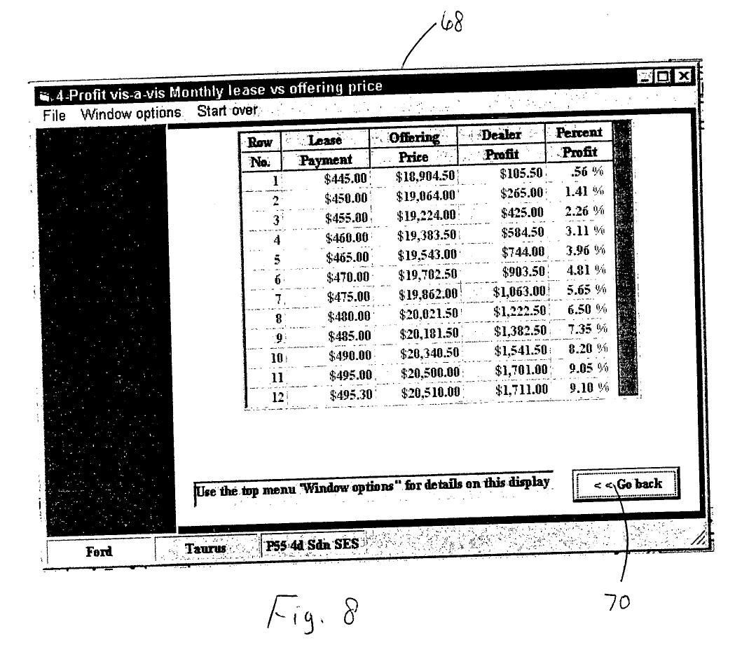

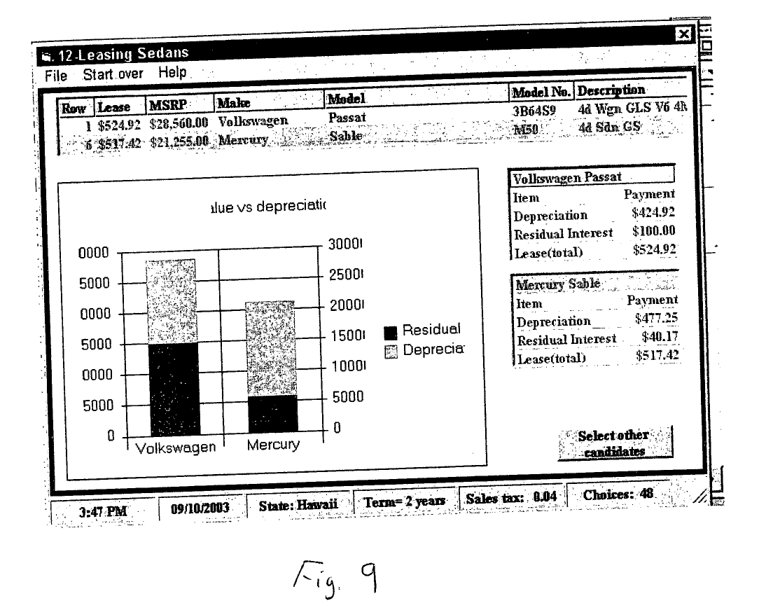

If the user has selected Lease (reference numeral 26) and Monthly payment (reference numeral 30) then when the user clicks the “Next” button they are taken to block 46 of FIG. 1. Block 46 represents Sheet 2, which is a block diagram shown in more detail in FIG. 4. Form or screen 12 (see FIG. 5) is displayed, which lists all vehicles in the database of vehicle information accessed by the program which fall within the monthly payment range specified at 43 in Form 29. As can be seen from FIG. 5, columns showing the row no., lease payment, MSRP, Make, Model, Model No. and Description are provided for each listed vehicle within the payment range.

Under the menu item “Window options”, at 51 in FIG. 5 are the items shown at reference numeral 48 of FIG. 5: “Show standard features” at 50; “Show individual financial data” at 52, and “Compare any two vehicles” at 54. The user can adjust the click on any of the four highlighted areas in box 53 of FIG. 5 and adjust the high or low limits, the spread between the high or low limits and the interest rate, using the slide bar 55.

FIG. 5A shows form or screen 12 with the “Help” menu displayed. If the user selects any of the available help items a window with an explanation of the selected item is displayed.

FIG. 5B shows the drop down menu under menu heading “Sort Data”, which allows sorting and merging the data in either descending or ascending order; to sort “By Common options” at 56; and to sort “By Standard features” at 58.

If item 50 is selected from the Window options of form 12 of FIG. 5, the user is prompted to select a row, and the standard features of the selected vehicle are displayed as shown in FIG. 6 (form or screen 11), as shown at block 62 of FIGS. 4 and 6.

If item 52 is selected from the Window options of form 12 of FIG. 5, the user is prompted to click in the Model column of any vehicle row, a “Show Financial Data” button is displayed on form 12 (see FIG. 5B), which when selected takes the user to block 64 of FIG. 4, or form 20, which is shown in detail at FIG. 7.

FIG. 7 displays financial information about the selected vehicle for the selected vehicle given the parameters entered at form 26 and form 29. The user can also change any of the items (except row 5 holdback) in Items 71 in FIG. 7, using the slidebar. When the user clicks on the holdback cell in row 5, a message box opens (see FIG. 7A) which explains holdback to the user. If the user clicks on the “Show payment vs. dealer profit” button 66 of form 20, then form 4 is displayed (FIG. 8), as shown at block 68 in FIG. 4. Form 4 (reference numeral 68) is an amortization table for the vehicle shown on form 20, reflecting the interest rate, term, taxpayer status and dealer profit. The “Go back” button 70 in FIG. 8 (form 4) takes the user back to form 20 or FIG. 7. The “Pick a different vehicle” button 72 in form 20 takes the user back to form 12 or FIG. 5.

If item 54 is selected from the Window options of form 12, the user is prompted to click on the MSRP of two different vehicles listed in form 12, and then FIG. 9 is displayed, which shows some graphical and text information comparing the two selected vehicles.

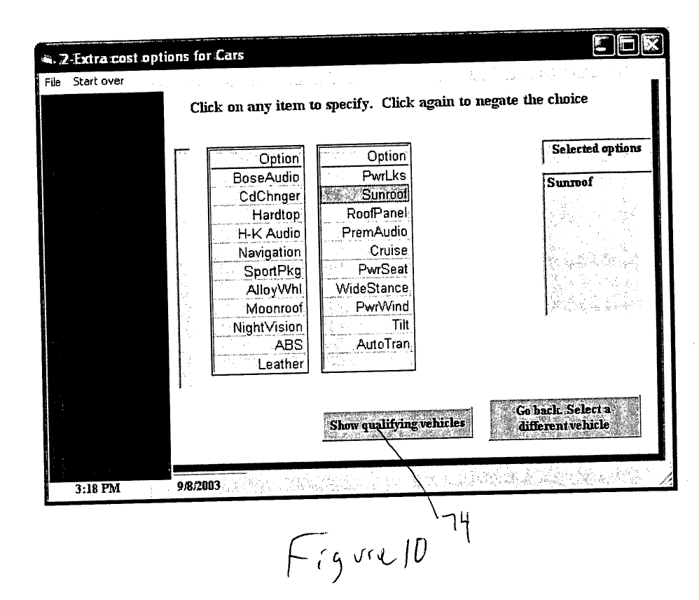

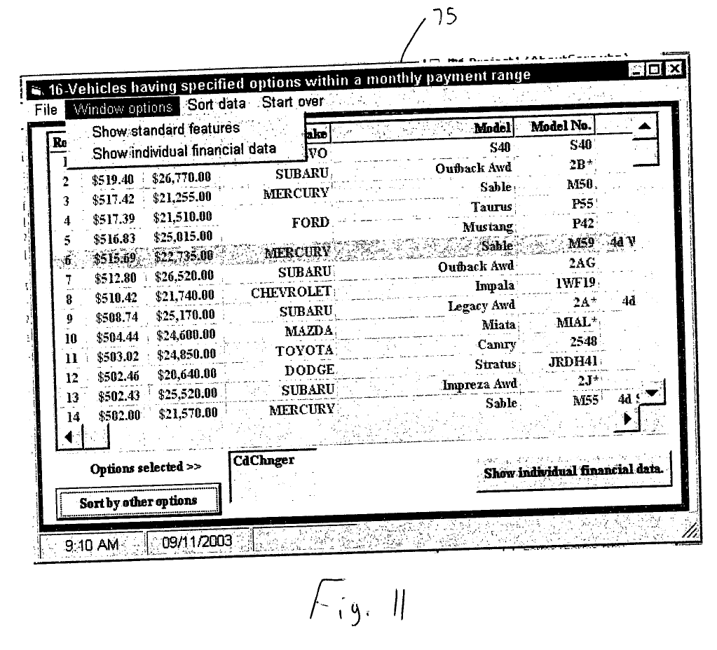

If item 56 is selected from the “Sort Data” menu of form 12, then the form of FIG. 10 is pulled up (reference numeral 73 from FIG. 4)(the options displayed in FIG. 10 is representative only), allowing the user to click on options, which are displayed in the “Selected options” list. Once the user clicks the “Show qualifying vehicles” button 74, form 12 is filtered as shown in form 16 (FIG. 11)(reference 75 from FIG. 4).

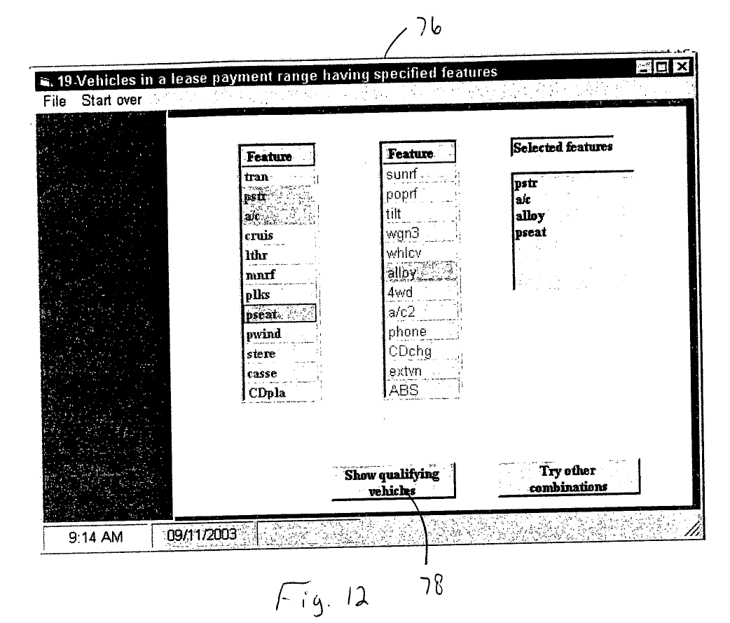

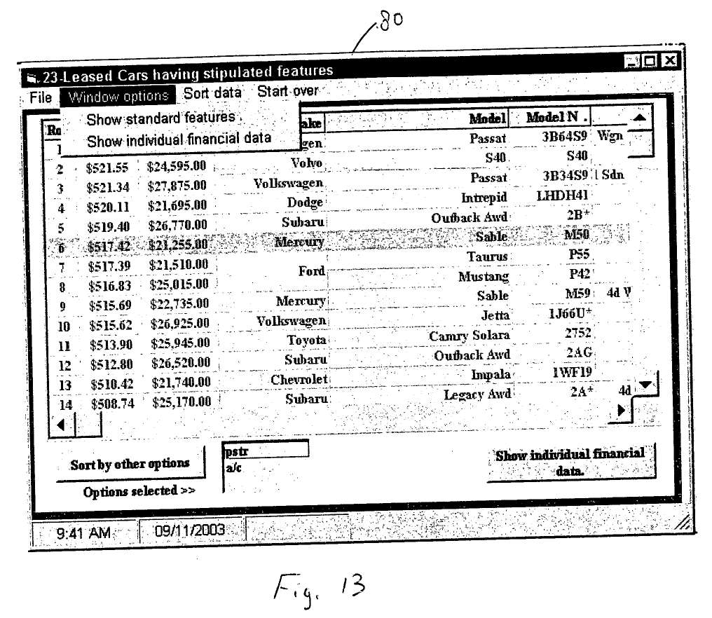

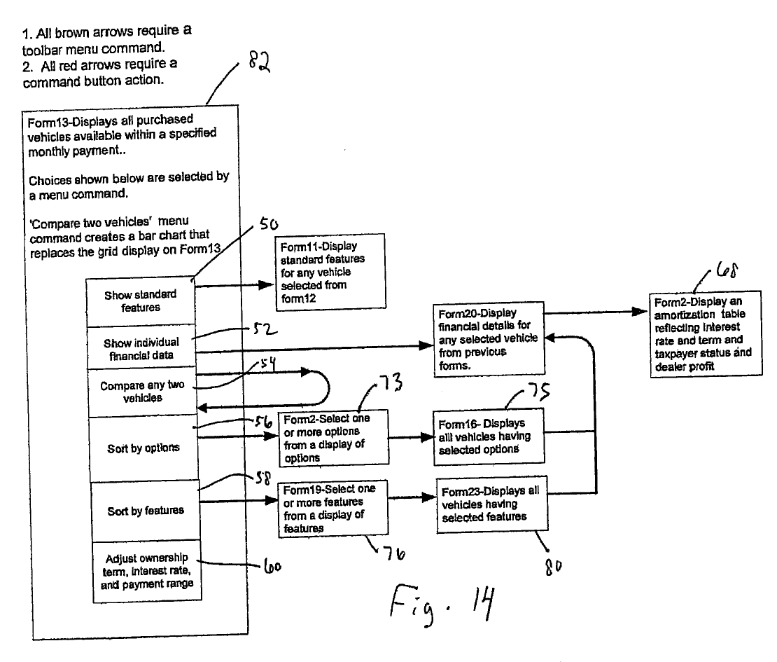

If item 58 is selected from the “Sort Data” menu of form 12, then the form of FIG. 12 is pulled up (form 19)(reference numeral 76 from FIG. 4), allowing the user to click on features, which are displayed in the “Selected features” list. Once the user clicks the “Show qualifying vehicles” button 78, form 12 is filtered as shown in form 23 (FIG. 13)(reference numeral 80 from FIG. 4).

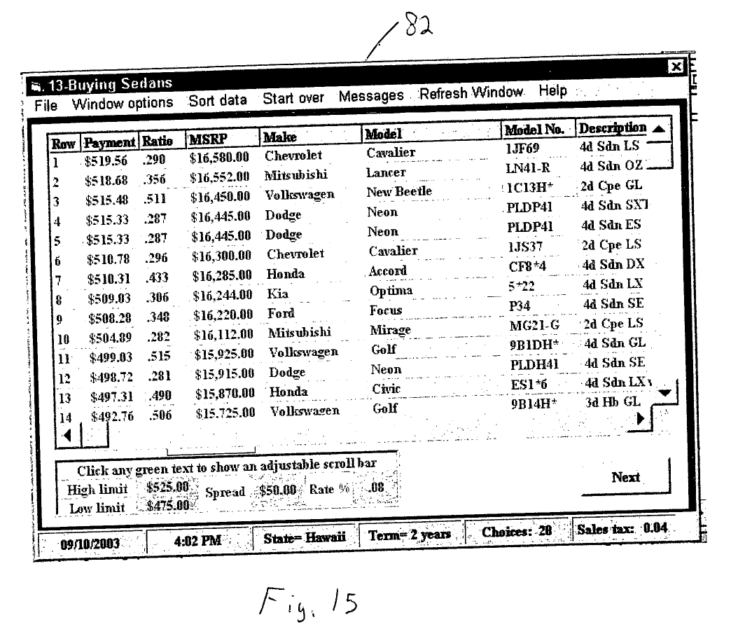

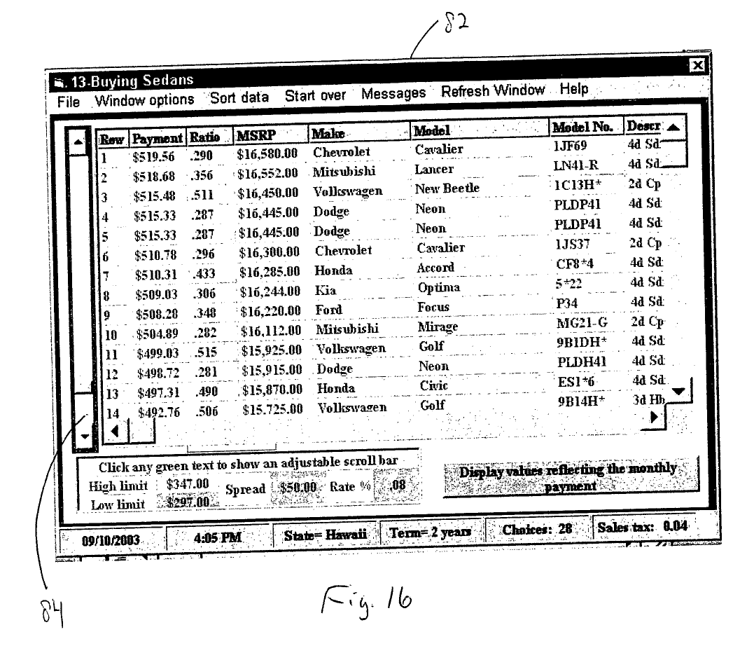

If the user has selected Buy (reference numeral 28) and Monthly payment (reference numeral 30) in FIG. 2 then when the user clicks the “Next” button they are taken to block 81 of FIG. 1. Block 81 represents Sheet 3, which is a block diagram shown in more detail in FIG. 14. Form or screen 13 (reference numeral 82 in FIG. 14)(see FIG. 15) is displayed, which lists all vehicles in the database of vehicle information accessed by the program which fall within the monthly payment range specified at 43 in Form 29. As can be seen from FIG. 15, columns showing the row no., lease payment, MSRP, Make, Model, Model No. and Description are provided for each listed vehicle within the payment range. The forms and flow of the program are the same for buying as they are for leasing (with the added column of “ratio”—which is the estimated trade divided by the MSRP), with the text headings of the various forms changed to reflect a purchase rather than a lease. Therefore, the reference numerals for the various blocks are the same in FIG. 14 as they are in FIG. 4.

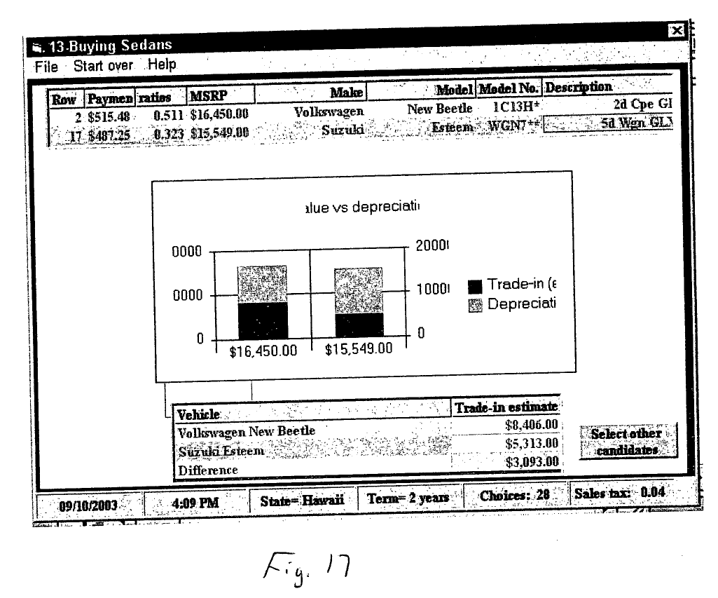

FIG. 16 illustrates a feature of the inventive program available for both the lease and buy options, discussed above. If the user clicks on any of the three cells high limit; low limit or spread, the slide bar 84 appears and can be used to adjust the selected cell. Form 13 if buying or form 12 if leasing is then updated with the list of vehicles matching the newly altered monthly payment range.

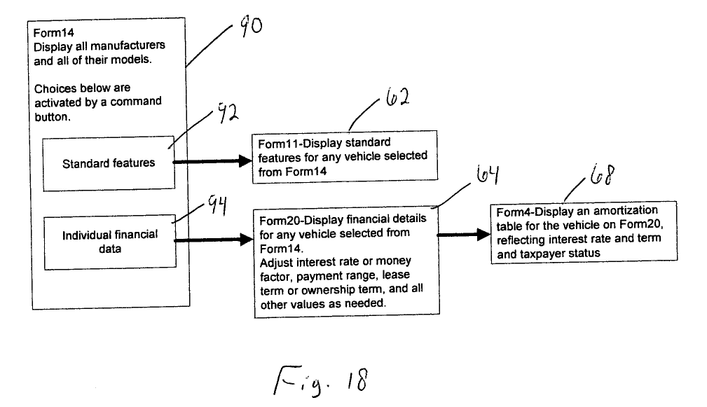

FIG. 17 shows the comparison of two vehicles under the buy option, similar to FIG. 9 for leasing.

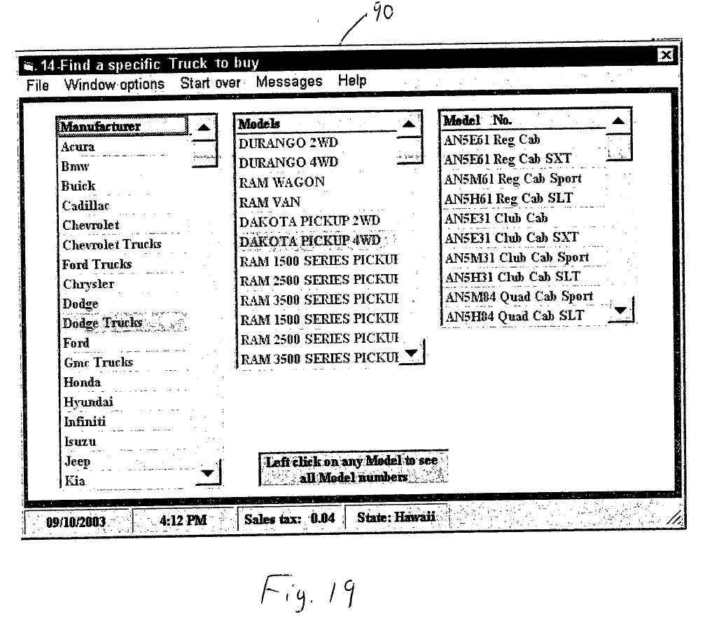

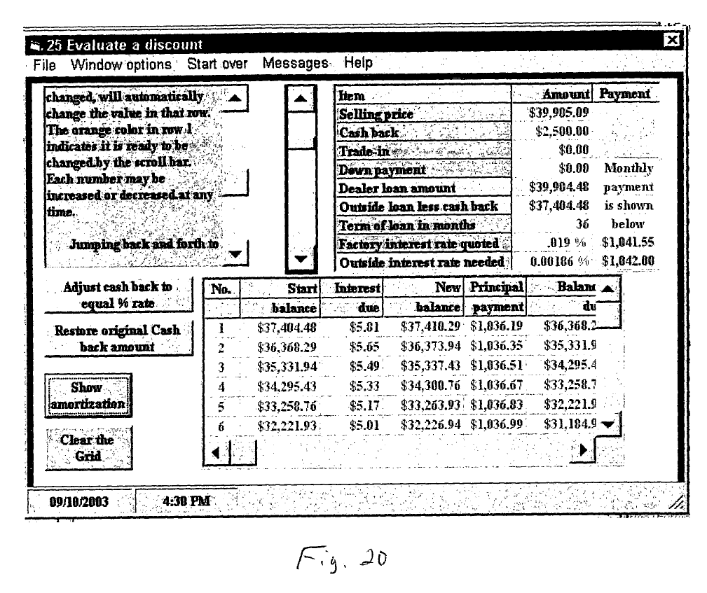

Referring again to FIG. 1, if the Maker button 32 is selected, along with either Lease or Buy, then Sheet 4 at 90 shows the forms available for this option. Form 14 at 90 in FIG. 19 allows the user to select either sedans or trucks, select a manufacturer and model, as shown in FIG. 19. Under the Window Options menu items are 92—“Standard features” and 94—“Individual financial data”. As discussed above in connection with the leasing or buying options, when a user selects either menu item 92 or 94 the forms at blocks 62 or 64 are activated. From the form of block 64 an amortization schedule can be pulled up at block 68, as discussed above.

Referring again to FIG. 1, selecting reference numeral 38 from FIG. 1 brings up the “Cash back analyses” screen 25 (FIG. 20). This screen allows a user to evaluate the differences between accepting a “cashback” offer from the dealer, with a low interest rate, or taking the cash and shopping for a third party loan.

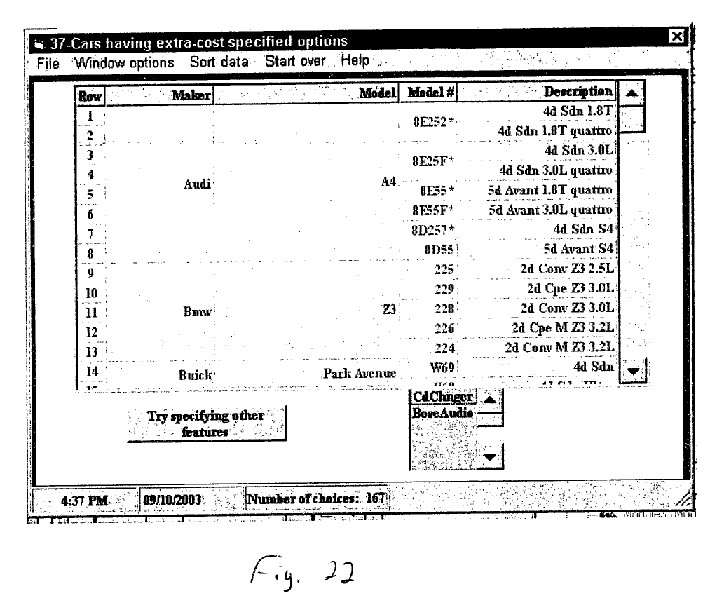

Referring again to FIG. 1, selecting button 34 and clicking “Next” takes the user to block 100, which is screen 9, shown in detail at FIG. 21. The user selects one or more options at this screen and then clicks the “Show qualified vehicles” button 102, which takes the user to block 104 in FIG. 1, which is screen 37, shown in detail at FIG. 22. FIG. 22 is a list of vehicles filtered to have the options selected in FIG. 21. As discussed above, the user may select a particular vehicle and pull up form 20 at block 64 of FIG. 1, and from form 20 may pull up an amortization at block 68 of FIG. 1.

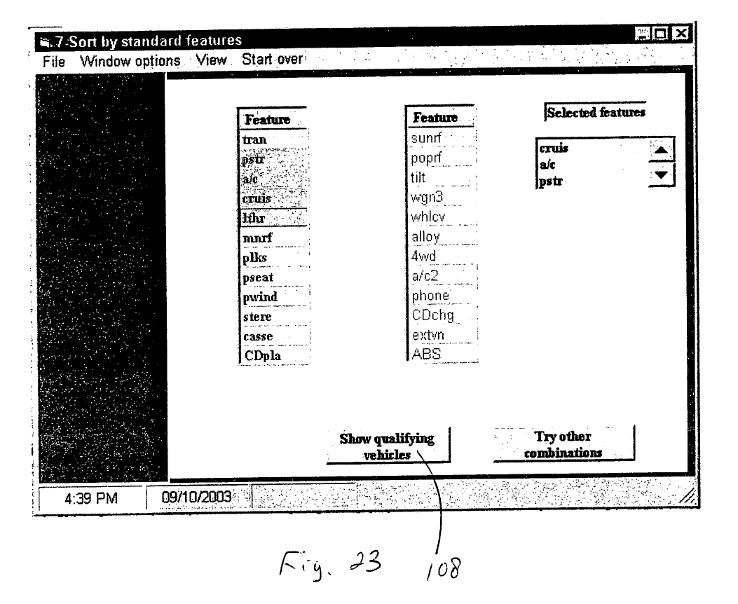

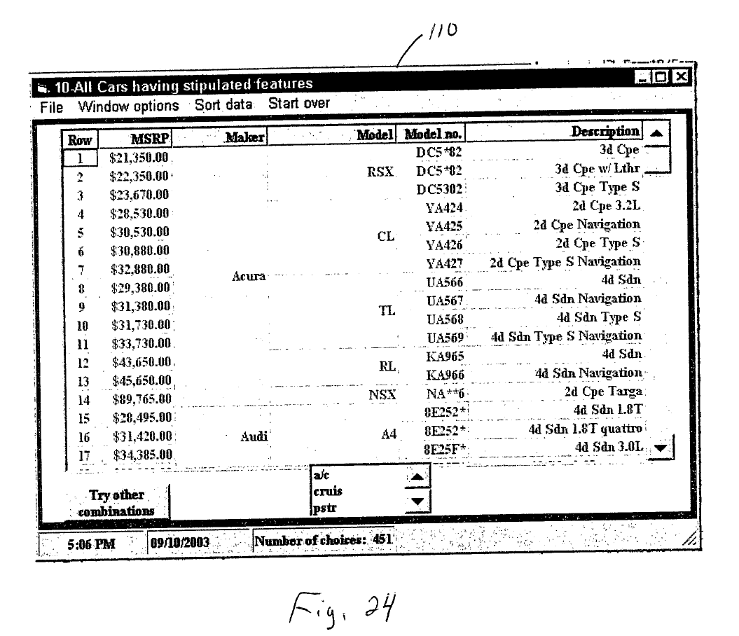

Referring again to FIG. 1, selecting button 36 and clicking “Next” takes the user to block 106, which is screen 7, shown in detail at FIG. 23. The user selects one or more features at this screen and then clicks the “Show qualified vehicles” button 108, which takes the user to block 110 in FIG. 1, which is screen 10, shown in detail at FIG. 24. FIG. 24 is a list of vehicles filtered to have the features selected in FIG. 23. As discussed above, the user may select a particular vehicle and pull up form 20 at block 64 of FIG. 1, and from form 20 may pull up an amortization at block 68 of FIG. 1.

Referring again to FIG. 1, selecting reference numeral 40 from FIG. 1 brings up the “lease detective” screen no. 22 (reference numeral 44 FIG. 1), shown at FIG. 25, which allows the user to adjust and change the various credits, interest rate, money factors etc. to arrive at an offer based on a monthly lease cost. The numbers in the “Confirm” column as calculated assume that the other four entries in the “Quoted” column are accurate. If the “Confirm” numbers do not match the numbers the dealer is quoting than one of the four variables in the “Quoted” column may include some charge not disclosed by the dealer.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

What is claimed is:

1. A vehicle lease or purchase evaluation system comprising:
a computer;
a database of vehicle information;
a computer program configured to run in the computer and having access to the database of vehicle information;
the computer program configured to provide a list of vehicles having a monthly payment falling within a user defined range, given a term and interest rate.

2. The vehicle lease or purchase evaluation system of claim 1 wherein the monthly payment is a purchase payment.

3. The vehicle lease or purchase evaluation system of claim 1 wherein the monthly payment is a lease payment.

4. The vehicle lease or purchase evaluation system of claim 1 wherein the vehicles may be sorted by a column selected from the group consisting of monthly payment; MSRP; Make, and Model.

5. The vehicle lease or purchase evaluation system of claim 1 wherein the vehicles may be sorted by one or more selected vehicle features.

6. The vehicle lease or purchase evaluation system of claim 1 wherein the vehicles may be filtered by selecting one or more features which the listed vehicles must have.

7. The vehicle lease or purchase evaluation system of claim 1 wherein two of the listed vehicles may be selected by the user for a more detailed comparison.

8. The vehicle lease or purchase evaluation system of claim 7 wherein the detailed comparison takes the form of a graphical display.

9. The vehicle lease or purchase evaluation system of claim 1 wherein the database contains data on all vehicles available for lease or purchase in the United States.

10. The vehicle lease or purchase evaluation system of claim 2 wherein for each vehicle listed a ratio is provided of the residual value of the vehicle, based on a lease term and interest rate which are the same as the purchase term and interest rate, to the MSRP value of the vehicle.

11. The vehicle lease or purchase evaluation system of claim 10 wherein the vehicles may be sorted by a column selected from the group consisting of monthly payment; ratio; MSRP; Make, and Model.

12. The vehicle lease or purchase evaluation system of claim 1 wherein a user defined down payment may be entered to assess its affect on the monthly payment.

13. The vehicle lease or purchase evaluation system of claim 1 wherein a user defined trade-in amount may be entered to assess its affect on the monthly payment.

14. The vehicle lease or purchase evaluation system of claim 1 wherein a user defined dealer rebate may be entered to assess its affect on the monthly payment.

15. The vehicle lease or purchase evaluation system of claim 1 wherein a user defined factory incentive amount may be entered to assess its affect on the monthly payment or dealer profit.

16. The vehicle lease or purchase evaluation system of claim 1 wherein a user defined holdback amount may be entered to assess its affect on the monthly payment.

17. The vehicle lease or purchase evaluation system of claim 2 wherein the program computes an offer amount for a selected vehicle based on a monthly payment amount and dealer profit.

18. The vehicle lease or purchase evaluation system of claim 3 wherein the program is configured to compute a confirmation selling price and lease payment for a selected vehicle given a dealer provide selling price; lease payment; residual amount and interest rate and a user provide term.

19. The vehicle lease or purchase evaluation system of claim 2 wherein the program is configured to compute a monthly payment depending on a cashback offer from a dealer with a first dealer provided interest rate versus taking the cash back and obtaining a third party loan at a second user provided interest rate, both for a user provided term.

20. A method of evaluating a vehicle lease or purchase comprising the steps of:
providing a computer program a database of vehicle information;
providing the computer program a user defined term;
providing the computer program a user defined interest rate;
providing the computer program a range of monthly payment, and listing all the vehicles contained in the database which fall within the monthly payment range.

21. The method of evaluating a vehicle lease or purchase of claim 20 wherein the monthly payment is a purchase payment.

22. The method of evaluating a vehicle lease or purchase of claim 20 wherein the monthly payment is a lease payment.

23. The method of evaluating a vehicle lease or purchase of claim 20 wherein the vehicles may be sorted by a column selected from the group consisting of monthly payment; MSRP; Make, and Model.

24. The method of evaluating a vehicle lease or purchase of claim 20 wherein the vehicles may be sorted by one or more selected vehicle features.

25. The method of evaluating a vehicle lease or purchase of claim 20 wherein the vehicles may be filtered by selecting one or more features which the listed vehicles must have.

26. The method of evaluating a vehicle lease or purchase of claim 20 wherein two of the listed vehicles may be selected by the user for a more detailed comparison.

27. The method of evaluating a vehicle lease or purchase of claim 26 wherein the detailed comparison takes the form of a graphical display.

28. The method of evaluating a vehicle lease or purchase of claim 20 wherein the database contains data on all vehicles available for lease or purchase in the United States.

29. The method of evaluating a vehicle lease or purchase of claim 21 wherein a ratio is provided of the residual value of the vehicle for each vehicle listed based on a lease term and interest rate which are the same as the purchase term and interest rate, to the MSRP value of the vehicle.

30. The method of evaluating a vehicle lease or purchase of claim 29 wherein the vehicles may be sorted by a column selected from the group consisting of monthly payment; ratio; MSRP; Make, and Model.

31. The method of evaluating a vehicle lease or purchase of claim 20 wherein a user defined down payment may be entered to assess its affect on the monthly payment.

32. The method of evaluating a vehicle lease or purchase of claim 20 wherein a user defined trade-in amount may be entered to assess its affect on the monthly payment.

33. The method of evaluating a vehicle lease or purchase of claim 20 wherein a user defined dealer rebate may be entered to assess its affect on the monthly payment.

34. The method of evaluating a vehicle lease or purchase of claim 20 wherein a user defined factory incentive amount may be entered to assess its affect on the monthly payment.

35. The method of evaluating a vehicle lease or purchase of claim 20 wherein a user defined holdback amount may be entered to assess its affect on the monthly payment.

36. The method of evaluating a vehicle lease or purchase of claim 21 wherein the program computes an offer amount for a selected vehicle based on a monthly payment amount and dealer profit.

37. The method of evaluating a vehicle lease or purchase of claim 22 wherein the program is configured to compute a confirmation selling price and lease payment for a selected vehicle given a dealer provide selling price; lease payment; residual amount and interest rate and a user provide term.

38. The method of evaluating a vehicle lease or purchase of claim 21 wherein the program is configured to compute a monthly payment depending on a cashback offer from a dealer with a first dealer provided interest rate versus taking the cash back and obtaining a third party loan at a second user provide interest rate, both for a user provided term.

39. An internet vehicle lease or purchase evaluation system, the system comprising:
a viewer computer configured for internet connection;
a server computer configured for internet connection and the display of web page content which includes a computer program request hyperlink;
a computer program configured to be transmitted through the internet from the server computer to the viewer computer when the computer program request hyperlink is clicked, wherein said computer program includes internet access to a database of vehicle information, the computer program configured to provide a list of vehicles having a monthly payment falling within a user defined range, given a term and interest rate.
